(19) United States
(12) Patent Application Publication
(10) Pub. No.: US 2010/0153166 A1
(43) Pub. Date: Jun. 17, 2010

(54) BUSINESS PROCESS WORKFLOW FLATTENING

(76) Inventor: PETER CHOLEWINSKI, Leon-Rot (DE)

Correspondence Address: MINTZ, LEVIN, COHN, FERRIS, GLOVSKY & POPEO, P.C., ONE FINANCIAL CENTER, BOSTON, MA, 02111, US

(21) Appl. No.: 12/335,428

(22) Filed: Dec. 15, 2008

(51) Int. Cl. G06Q 10/00; G06F 3/048; G06F 15/16

(52) U.S. Cl. 705/9; 715/866; 715/780; 709/206

(57) ABSTRACT

A graphical user interface is provided for the performance of process steps for one or more role-based activities for a business process. The business process is made up of a plurality of process steps, at least a portion of which require sequential completion by users having different roles. A user having two or more roles that is accessing the graphical user interface to perform a first process step can be presented with a graphical user interface element. The graphical user interface element, when activated, causes input fields corresponding to an input set to be completed by the user for an additional process step subsequent to both the first process step and a next process step subsequent to the first process step to be displayed. The first process step is associated with a first role, and the additional process step is associated with a second role. First user-generated input is received that selects the graphical user interface element. Second user-generated input is received that provides values for the input fields to generate input sets for the additional processing step. Thereafter, completion of the business process using the generated input sets is initiated. Related apparatus, systems, techniques and articles are also described.

### TECHNICAL FIELD

The subject matter described herein relates to selectively flattening several processing steps for users having different roles in a system implementing a business process workflow.

### BACKGROUND

Role-based business solution software applications are becoming increasingly adopted as companies seek to optimize their internal business processes. As an example, in a large organization, there may be several different users each having different roles within a business process. One user may focus solely on projects (as a project lead), one user may focus solely on procurement (as a procurer), and another user may focus solely on sourcing (as a buyer). Each such activity may be controlled by a software application that provides a custom interface for each user based on the role for such a user. For example, a procurer would only be able to perform procurement related tasks, the project lead would only be able to perform projects related tasks, and the buyer would only be able to perform sourcing related tasks.

In smaller organizations, a first user might have multiple roles which relate to activities having non-sequential processing steps (e.g., projects->procurement->sourcing). In other words, the first user might be responsible for projects and sourcing, while a second user is responsible for procurement. With such an arrangement, the first user is presented with a first screen (or work center) that relates to projects. The first user enters in relevant information that identifies the need for a good or service. Such information is then passed on to the second user for subsequent processing steps in a second screen (or work center) relating to procurement (to, for example, enrich the request from project management) and then back to the first user for even further subsequent processing steps in a third screen (or work center) (e.g., identifying where to obtain the good or service).

When a single user assumes multiple roles for a business process, such a user needs to have specialized knowledge associated for the screens presented in connection with the processing steps for each role. Moreover, switching between screens can cause delays and such screens can provide differing views of processes (which decreases usability).

As an abstract process flow example:

Process starts at step S1: entity E1 is created and forwarded.
Individual X (assigned to several roles) starts the process.

Process step S2 gets E1 (or its successor) and awaits processing.
X now needs to switch screens and look for E1 (or its successor) in the new screen.
X modifies E1 (or its successor) in certain scope as preparation for next step, forwards E1 (or its successor).

Process step S3 then gets E1 (or its successor).
X now again might needs to make choices, but first needs to find E1 (or its successor).

Having several roles leads to the following problems (even for simple tasks):
A user may have to look for main entity (E1) of a business process in several screens.
In many cases successor entities are created during the process with no direct linkage.
A user may need to learn different screens and roles although only one main role is necessary.

### SUMMARY

In one aspect, a graphical user interface is provided for the performance of process steps for one or more role-based activities for a business process. The business process is made up of a plurality of process steps, at least a portion of which require sequential completion by users having different roles. A user having two or more roles accesses the graphical user interface to perform a first process step is presented with a graphical user interface element. The graphical user interface element, when activated, causes input fields corresponding to an input set to be completed by the user for an additional process step subsequent to both the first process step and a next process step subsequent to the first process step to be displayed. The first process step is associated with a first role, and the additional process step is associated with a second role. First user-generated input is received that selects the graphical user interface element. Second user-generated input is received that provides values for the input fields to generate input sets for the additional processing step. Thereafter, completion of the business process using the generated input sets is initiated.

At least a portion of the input fields can be populated with default values not requiring user-generated input for values in the corresponding input set. Such default values can be presented to the user so that the user can modify the default values in the graphical user interface.

At least a portion of the input fields can be designated as variable and require user-generated input to populate values for the corresponding input set.

The business process can be completed, for example, without further user-generated input from the user after the second user-generated input to complete the business process. In other words, once the user has triggered a flattening of the business process, no further input may be required from that user (provided that the trigger relates to all roles of the user and/or that all processing steps associated with the user already have defined input sets).

Additional user-generated input can be received that bypasses the input of values for the input fields for the additional processing step so that the user is subsequently prompted to provide input values for the input fields when the business process advances to the additional process step.

The second user-generated input can be received during run-time of the business process or it can be received during configuration of the business process.

The input fields for the first processing step can be displayed on a first screen and the input fields for the additional processing step can be displayed on a second screen. Alternatively, the input fields for both the first processing step and the additional processing step can be displayed on a single screen.

In another interrelated aspect, a graphical user interface for performance of process steps for one or more role-based activities for a business process is provided in which at least a portion of the process steps require sequential completion by users having different roles. The graphical user interface can present, to a user having two or more roles that is accessing the graphical user interface to perform a first process step, a first graphical user interface element and a second graphical user interface element. The first graphical user interface element, when activated, causes first input fields corresponding to a first input set to be completed by the user for the first process step to be displayed, the first process step being associated with a first role. The second graphical user interface element, when activated, causes both input fields corresponding to the first input set to be completed by the user for the first process step and second input fields corresponding to a second input set to be completed by the user for an additional process step subsequent to both the first process step and a next process step subsequent to the first process step to be displayed. The additional process step is associated with a second role. First user-generated input is received that selects either the first graphical user interface element or the second graphical user interface element. In response to the first user-generated input, completion of the business process is initiated with further input from the user for the additional process step if the first graphical user interface element is selected, or completion of the business process is initiated without further input from the user for the additional process step if the second graphical user interface element is selected.

Articles are also described that comprise a machine-readable medium embodying instructions that when performed by one or more machines result in operations described herein. Similarly, computer systems are also described that may include a processor and a memory coupled to the processor. The memory may encode one or more programs that cause the processor to perform one or more of the operations described herein.

The subject matter described herein provides many advantages. By allowing a user to concurrently perform processing steps associated with different roles, the user can operate more efficiently by avoiding the need to switch from one role view to another and the requirement to locate successor entities for an initiating entity. Therefore, the effectiveness of users of role-based solutions in smaller companies can be increased (due, in part, to the fact that the amount of time to switch, search, and learn new process steps/screens is eliminated).

The current subject matter also increases the ability of business users to influence standardized processes. These processes can be altered, for example, to align within internal capacity or work processes. In addition, when there is no longer a need for the altered processes, the standardized processes can be returned as if they had never been flattened.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating a technique for business process workflow flattening;

FIG. 2A is a diagram illustrating a series of processing steps to be sequentially executed that have triggers resulting in delivery of data characterizing the input set to the next subsequent processing step;

FIG. 2B is a diagram illustrating a series of processing steps to be sequentially executed that have triggers resulting in delivery of data characterizing the input set to the next subsequent processing step and triggers resulting in bypassing user input for at least one processing step;

FIG. 2C is a diagram illustrating processing steps to be executed after initiation of a trigger bypassing user input for at least one processing step; and

FIG. 3 is a diagram illustrating a plurality of input sets having associated default values and variable values.

Like reference symbols in the various drawings indicate like elements.

### DETAILED DESCRIPTION

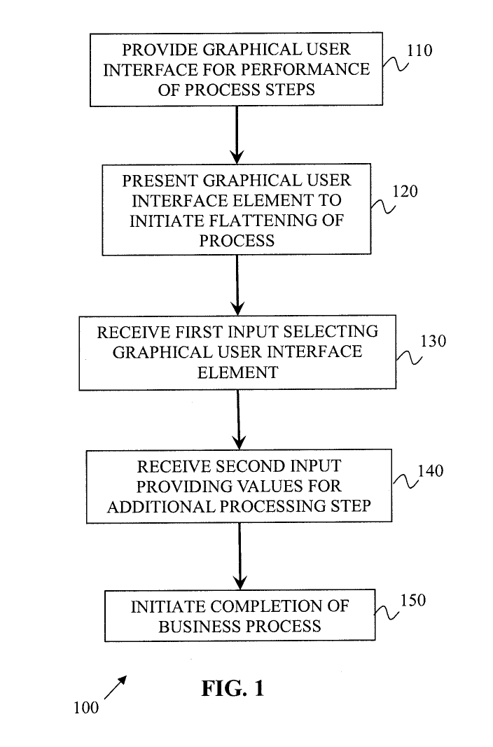

FIG. 1 is a process flow diagram illustrating a method 100, in which a graphical user interface is provided, at 110, for the performance of process steps for one or more role-based activities for a business process. The business process is made up of a plurality of process steps, at least a portion of which require sequential completion by users having different roles. A user having two or more roles that accesses the graphical user interface to perform a first process step is presented, at 120, with a graphical user interface element. The graphical user interface element, when activated, causes input fields corresponding to an input set to be completed by the user for an additional process step subsequent to both the first process step and a next process step subsequent to the first process step to be displayed. The first process step is associated with a first role, and the additional process step is associated with a second role. First user-generated input is received, at 130, that selects the graphical user interface element. Second user-generated input is received, at 140, that provides values for the input fields to generate input sets for the additional processing step. Thereafter, at 150, completion of the business process using the generated input sets is initiated.

The current subject matter can minimize the number of graphical user interface screens with which a user having several roles in connection with a business process system operating across one or more computer systems interacts.

A flattening option can be provided for a process where the user has access to a source trigger (button, status change, etc.) that can, from the user's point of view, flatten the business process (e.g., allow for process steps having different input sets to be simultaneously presented in a single screen or to be presented one after another (i.e., out of order)). The source trigger can be initiated, during configuration of the business process. Alternatively, a graphical user interface element can be provided in a screen presented to the user, which, when activated, causes the source trigger to be triggered.

The user, via the graphical user interface element, can choose to flatten a process that starts at the given trigger. Upon activation of the graphical user interface element, the trigger can be replaced with an ordinary process trigger and a new flattened process trigger. As part of flattening the process, the user is offered the subsequent screens of the process steps where he/she has access to, or in the alternative, the relevant portions of the subsequent screens can be combined on an earlier screen.

Moreover, the user can choose default values or can select specific fields to be shown when the flattened process trigger is initiated. The choices can be saved so that the trigger becomes a permanent part of the screen. Thereafter, the user can use the flattened trigger as a short cut through several process steps. In addition, initiating the flattened trigger can result in the fields the user chose to be variable being presented in one or more screens (to allow the user to fill in values for such field in the subsequent processing steps).

The process then is started and the next processing steps can be triggered without interaction of the user using the default or values of the offered fields as input.

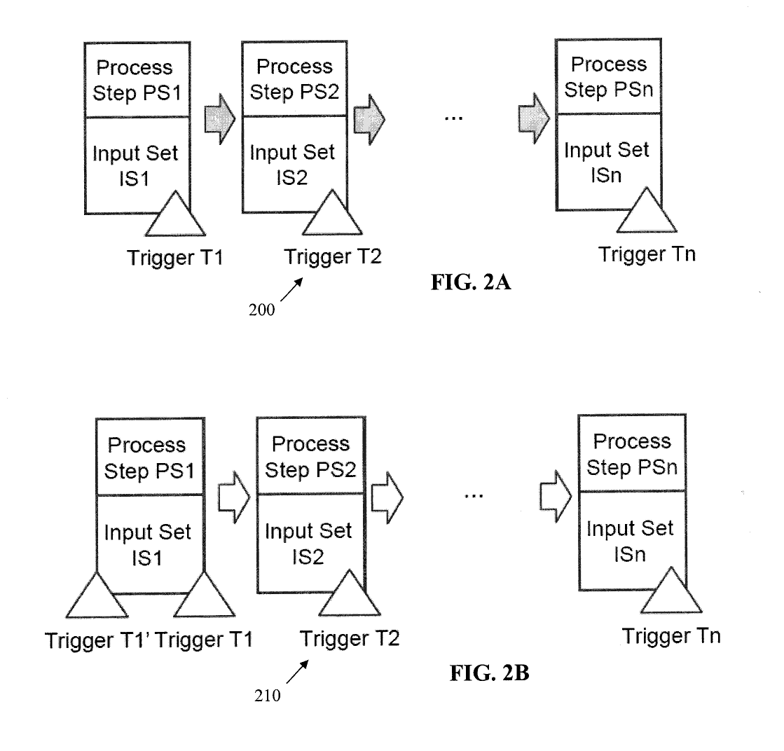

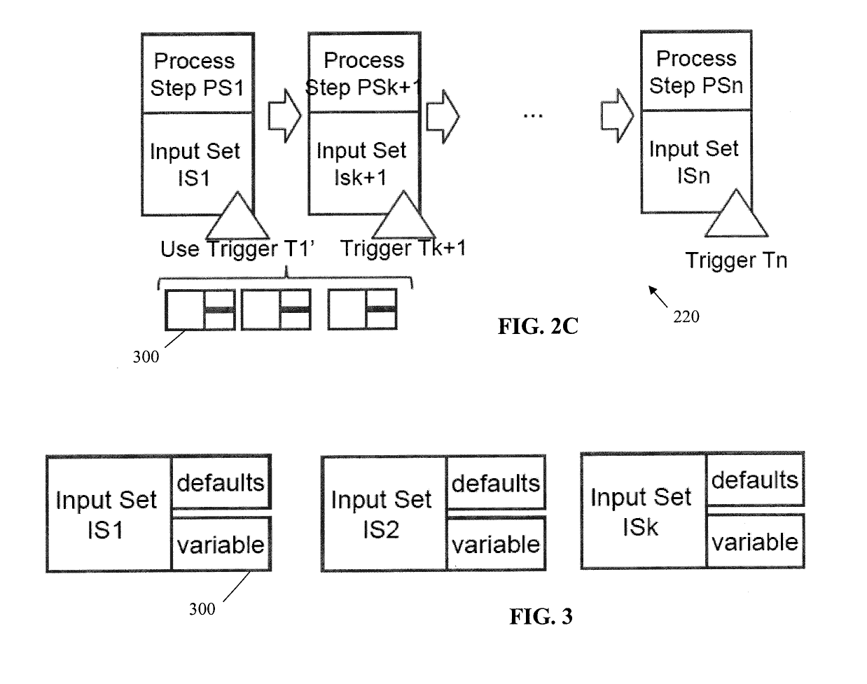

FIG. 2A is a diagram 200 that illustrates a user deciding to flatten a process starting at Process Step PSI so that it includes Process Steps PS2, PS3, . . . , PSk (k<=n). As illustrated, there are n process steps which are visible to a user that has two or more roles. Each process step requires values to proceed to the next process step. These values take the form of an input set which are passed to the subsequent process step (through, for example, message exchange to one or more remote computing systems, etc.). Each process step has a trigger to initiate the next process step (which involves passing the input set from the process step to the next process step). Any particular input set might be null. In addition, there may not always be triggers associated with each process step.

In such an arrangement, a user can activate a graphical user interface element corresponding to Trigger T1 to select a flattening option. The user can be presented, via a graphical user interface, the input sets of the subsequent process steps to which the user has access to due to his or her role assignment (user only selects up to ISk per assumption). In addition, the user can select, via the graphical user interface, as illustrated in diagram 300 of FIG. 2, whether each input set has values that are to be maintained in a set manner (e.g., default values) when the flattened process is triggered, or whether certain values are to be entered by the user when the flattened process is triggered (e.g., variable values).

With reference now to the diagram 210 of FIG. 2B and diagram 220 of FIG. 2C, after confirming the selection of the input sets the user is provided with a new trigger—trigger T1′. T1′ is now the trigger for the next process step PSk+1. When the user uses T1 then normal process steps subsequent to process step PS1 would be triggered which would require the user to provide the corresponding input sets. However, when the user triggers T1′, one or more of the input sets IS2, . . . , ISk are pre-filled with the defaults if such a configuration is selected and/or one or more of the input sets are rendered in the graphical user interface to allow the user to fill them in at once (rather than waiting for other process steps which might potentially require users with different roles to provide some input). These input sets (whether default or user-generated), are then used to work on subsequent processing steps without further interaction from the user. Alternatively, the variable labeled subsets of some input sets can be shown when automation reaches a pre-defined process step.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Moreover, while certain examples are described in connection with first and second process steps, it will be appreciated that a user may flatten any of a plurality of process steps that are associated with the roles of the user. Other embodiments may be within the scope of the following claims.

What is claimed is:

1. An article comprising a tangible machine-readable storage medium embodying instructions that when performed by one or more machines result in operations comprising:
providing a graphical user interface for performance of process steps for one or more role-based activities for a business process, at least a portion of the process steps requiring sequential completion by users having different roles;
presenting, to a user having two or more roles that is accessing the graphical user interface to perform a first process step, a graphical user interface element which, when activated, causes input fields corresponding to an input set to be completed by the user for an additional process step subsequent to both the first process step and a next process step subsequent to the first process step to be displayed, the first process step being associated with a first role, and the additional process step being associated with a second role;
receiving first user-generated input selecting the graphical user interface element; and
receiving second user-generated input providing values for the input fields to generate input sets for the additional processing step; and
initiating completion of the business process using the generated input sets.

2. An article as in claim 1, wherein at least a portion of the input fields are populated with default values not requiring user-generated input for values in the corresponding input set.

3. An article as in claim 2, wherein the default values are presented to the user and the user can modify the default values in the graphical user interface.

4. An article as in claim 1, wherein at least a portion of the input fields are designated as variable and require user-generated input to populate values for the corresponding input set.

5. An article as in claim 1, wherein no further user-generated input is required from the user after the second user-generated input to complete the business process.

6. An article as in claim 1, wherein the tangible machine-readable storage medium further embodies instructions that when performed by one or more machines result in operations comprising:
receiving third user-generated input bypassing the input of values for the input fields so that the user is subsequently prompted to provide input values for the input fields when the business process advances to the additional process step.

7. An article as in claim 1, wherein the second user-generated input is received during run-time of the business process.

8. An article as in claim 1, wherein the second-user generated input is received during configuration of the business process.

9. An article as in claim 1, wherein input fields for the first processing step are displayed on a first screen and the input fields for the additional processing step are displayed on a second screen.

10. A method to be performed by execution of computer readable program code by at least one processor of at least one computer system, the method comprising:
providing a graphical user interface for performance of process steps for one or more role-based activities for a business process, at least a portion of the process steps requiring sequential completion by users having different roles;
presenting, to a user having two or more roles that is accessing the graphical user interface to perform a first process step, a graphical user interface element which, when activated, causes input fields corresponding to an input set to be completed by the user for an additional process step subsequent to both the first process step and a next process step subsequent to the first process step to be displayed, the first process step being associated with a first role, and the additional process step being associated with a second role;
receiving first user-generated input selecting the graphical user interface element; and
receiving second user-generated input providing values for the input fields to generate input sets for the additional processing step; and
initiating completion of the business process using the generated input sets.

11. A method as in claim 10, wherein at least a portion of the input fields are populated with default values not requiring user-generated input for values in the corresponding input set.

12. A method as in claim 11, wherein the default values are presented to the user and the user can modify the default values in the graphical user interface.

13. A method as in claim 10, wherein at least a portion of the input fields are designated as variable and require user-generated input to populate values for the corresponding input set.

14. A method as in claim 10, wherein no further user-generated input is required from the user after the second user-generated input to complete the business process.

15. A method as in claim 10 further comprising:
receiving third user-generated input bypassing the input of values for the input fields so that the user is subsequently prompted to provide input values for the input fields when the business process advances to the additional process step.

16. A method as in claim 10, wherein the second user-generated input is received during run-time of the business process.

17. A method as in claim 10, wherein the second-user generated input is received during configuration of the business process.

18. A method as in claim 10, wherein input fields for the first processing step are displayed on a first screen and the input fields for the additional processing step are displayed on a second screen.

19. An article comprising a tangible machine-readable storage medium embodying instructions that when performed by one or more machines result in operations comprising:
providing a graphical user interface for performance of process steps for one or more role-based activities for a business process, at least a portion of the process steps requiring sequential completion by users having different roles;
presenting, to a user having two or more roles that is accessing the graphical user interface to perform a first process step, a first graphical user interface element and a second graphical user interface element, the first graphical user interface element, when activated, causes first input fields corresponding to a first input set to be completed by the user for the first process step to be displayed, the first process step being associated with a first role, the second graphical user interface element, when activated, causes input fields corresponding both to the first input fields corresponding to the first input set to be completed by the user for the first process step and second input fields corresponding to a second input set to be completed by the user for an additional process step subsequent to both the first process step and a next process step subsequent to the first process step to be displayed, the additional process step being associated with a second role; and
receiving first user-generated input selecting either the first graphical user interface element or the second graphical user interface element; and
initiating completion of the business process with further input from the user for the additional process step if the first graphical user interface element is selected, or initiating completion of the business process without further input from the user for the additional process step if the second graphical user interface element is selected.

20. An article as in claim 19, wherein data characterizing the input sets are encapsulated in messages that are transmitted to one or more computers associated with the next subsequent processing step.
